(19) United States
(12) Patent Application Publication
(10) Pub. No.: US 2002/0088427 A1
(43) Pub. Date: Jul. 11, 2002

(54) Rotary gear enging

(76) Inventor: Jung-Kuang Chou, Taipei (TW)

Correspondence Address: Yung-Kuang Chou, P.O. Box 82-144, Taipei, TW

(21) Appl. No.: 09/755,064

(22) Filed: Jan. 8, 2001

(51) Int. Cl. F02B 53/04

(52) U.S. Cl. 123/203; 123/217

(57) ABSTRACT

A rotary gear engine includes a gear pump or a Root's blower which can operate at expansion and contraction conditions and is generally comprised of a pair of gears with identical pitch or rotors meshed with each other and mounted on a pair of parallel axles, a vacuum hood and an exhaust hood mounted opposite to the connection between the two gears and closely fitted together with the gears in a cylinder, whereby when in operation, the engine sucks in air at one end and exhaust waste gas at the other to perform intake and exhaust strokes. The combustion chambers and ignition device are provided for obtaining combustion function in compression stroke, and compressed air may be input from the outside or the high pressure gas generated by the combustion chamber may be used for compressing the input low pressure air, and alternatively, a portion of the exhaust gas may be fed back to the combustion chamber to increase the pressure so as to increase the combustion rate to obtain the explosion function thereby providing an engine of high performance.

### BACKGROUND OF THE INVENTION

a. Technical Field of the Invention

This invention is related to a rotary gear engine and in particular to which is one of high efficiency, compact in size, stable and quiet in operation and excellent in acceleration and can work without cooling or ignition control system

b. Description of the Prior Art

Airplanes and ships require large quantities of horsepower. Therefore, they must use jet engines or turbines. For machines requiring smaller amounts of power, a reciprocating engine is the only engine available for use. This has generally been sufficient.

In 1957 a German engineer called Wankel invented a rotary triangular piston engine, which is simple in construction, compact in size and lightweight and produces low levels of noise. The efficiency of this kind of engine is seven percent higher than the reciprocating engine. Mazda automobile company has adopted this engine in millions of cars.

However, such an engine still suffers from the following drawbacks:

First, the rotary piston engine has a triangular piston rotating in an elliptical cylinder. When the gas within the cylinder explodes, the piston body will oscillate.

Secondly, although it is unnecessary for this kind of engine to have intake and exhaust valves, the reaction force is exerted on an inclined surface and the exhaust stroke is relatively short, so that the conversion from the thrust produced by the gas pressure into mechanical power is limited. A portion of dynamic will be exhausted as a result of this conversion, which wastes a lot of energy and so that its output torque at low speed is very low.

As for the reciprocating piston engine, there must be a clearance between the piston and the cylinder in order to enable the piston to move within the cylinder. Hence, it is necessary to use a cooling system to lower its temperature in order to prevent expansion and contraction of the parts. Therefore the combustion efficiency will be influenced and at least 30 percent of the energy in cooling system is wasted.

Therefore, it is an object of the present invention to provide a rotary gear engine which can obviate and mitigate the above-mentioned drawbacks.

### SUMMARY OF THE INVENTION

This invention is related to a rotary gear engine and in particular to which is one of high performance.

It is an object of the present invention to provide a rotary gear engine includes a gear pump or a Root's blower which can operate at expansion and contraction conditions and is generally comprised of a pair of gears with identical pitch or rotors meshed with each other and mounted on a pair of parallel axles, a vacuum hood and an exhaust hood mounted opposite to the connection between the two gears and closely fitted together with the gears in a cylinder, whereby when in operation, the engine sucks in air at one end and exhaust waste gas at the other to perform intake and exhaust strokes, and combustion chambers and ignition device are provided for obtaining combustion function in compression stroke, and compressed air may be input from the outside or the high pressure gas generated by the combustion chamber may be used for compressing the input low pressure air, and alternatively, a portion of the exhaust gas may be fed back to the combustion chamber to increase the pressure so as to increase the combustion rate to obtain the explosion function thereby providing an engine of high performance.

### BRIEF DESCRIPTION OF THE DRAWINGS

FIG. 1 is a sectional view of the present invention;

FIG. 2 is an exploded view of the present invention;

FIG. 3 is a perspective view of the main portion of the present invention; and

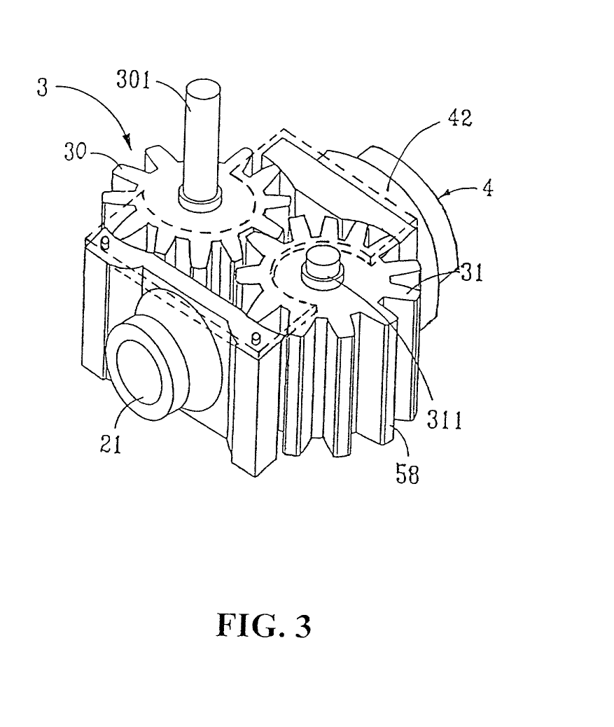

FIG. 4 is a perspective view of the present invention.

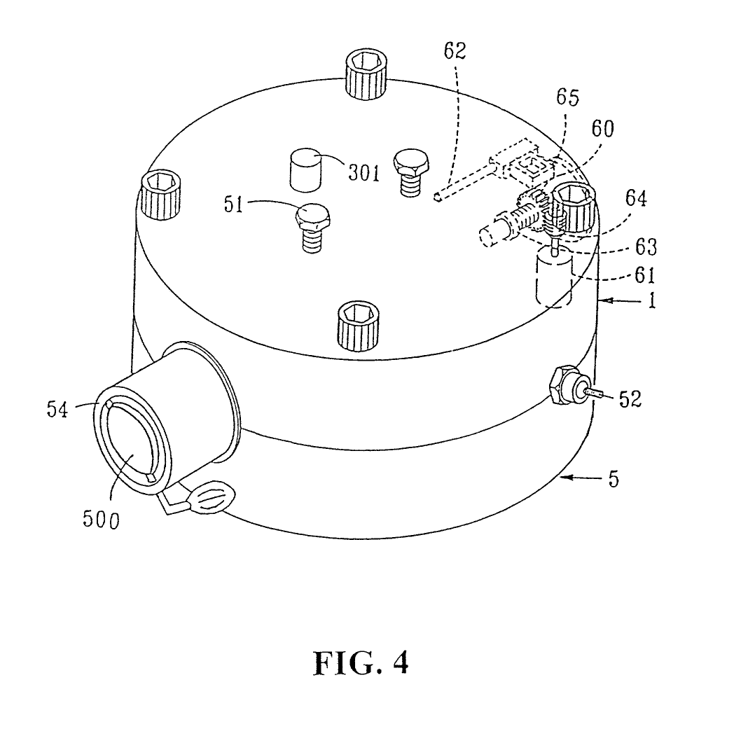

### DETAILED DESCRIPTION OF THE PRESENT INVENTION

Jet engines provide continuous combustion of a mixture of air and gas thereby providing stable operation. Furthermore, the combustion temperature is high, resulting in complete combustion. However, the power generated by jet engines is fluid power which has to be converted into mechanical power by a plurality of impellers thus occupying a relatively large space. In addition, the combustion chamber of jet engines is open, increasing the fuel consumption and being unfit for low speed operation. According to the development of engines, one or two explosion strokes in two turns for the conventional engine has been changed to three explosion strokes per turn for the rotary engine thus reducing the size and noise and increasing power, acceleration ability and combustion efficiency. In view of the future development of engines, the engine must be an internal combustion engine of continuous combustion.

This invention utilizes the intake and exhaust functions of Root's blower or gear pump (which has been confirmed by the public) in association with a combustion chamber and an igniting device between the intake and exhaust so as to perform explosion stroke. As to the compression stroke, compressed air may be input from the outside or the high pressure gas generated by the combustion chamber is used for compressing the input low pressure air.

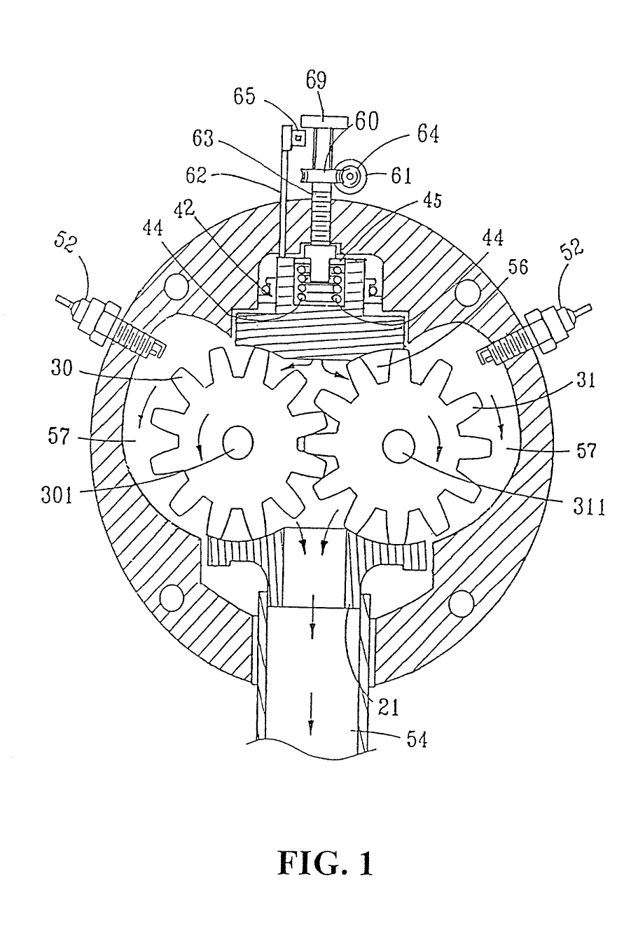

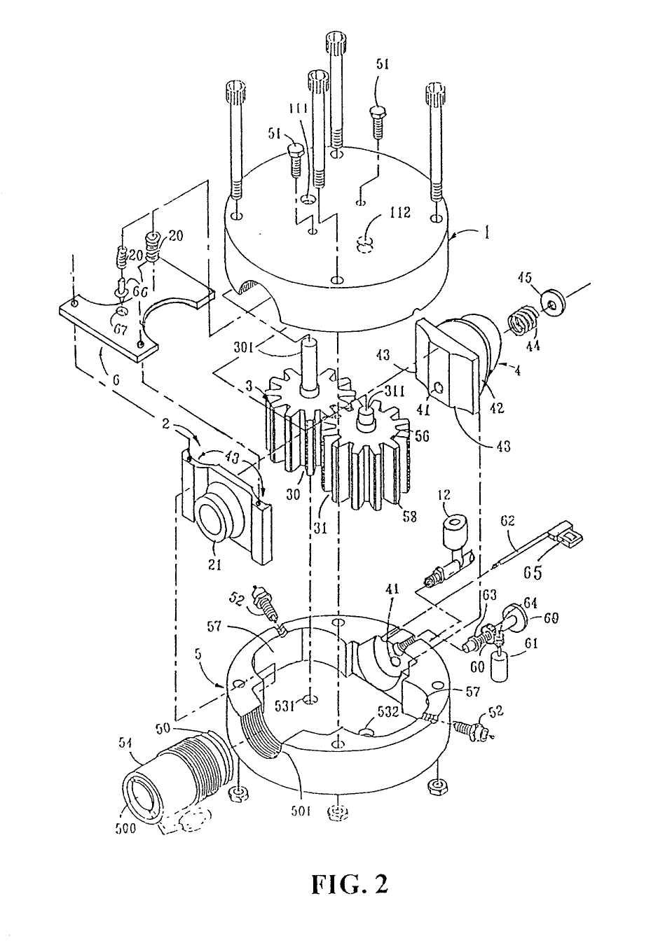

Alternatively, a portion of the exhaust gas may be fed back to the combustion chamber to increase the pressure so as to increase the combustion rate. The combustion chamber is closed no matter whether the engine is in operation or not thus making it fit for slow operation at low pressure. This present invention operates at a continuous combustion mode so that the residue temperature in the combustion chamber 57 is very high. Hence, the inner lining of the combustion chamber 57 must be made of heat insulation material such as silicon carbon or ceramic and the gears and accessories must be made of metals with high melting points. Furthermore, the outer side of the engine according to the present invention is cooled by air thereby providing a preheated air for the combustion. Referring to FIGS. 1 and 2, two gears 30 and 31 of identical pitch are rotated by a motor to produce vacuum and then preheated air passes through a carburetor 12 thereby drawing combustible gas from an inlet 41 into a cylinder composed of an upper cylinder 1 and a lower cylinder 5. Thereafter, the combustible gas fills into the space between teeth of the two gears 30 and 31 and two combustion chambers 57. Finally, the spark plug 52 ignites the combustible gas thereby generating a large amount of gas flow to rotate the gears 30 and 31. Meanwhile, the teeth of the gears 30 and 31 push the exhaust gas out of the cylinder. As the beginning of the operation of the engine, the temperature of the combustion chamber is low and so it is not easy to raise the rotation speed or torque in a short time. Hence, the valve 500 is controlled to feed a portion of exhaust gas from a single-way hole 67 back to the rear portion of the combustion chambers thereby increasing the speed of combustion and providing excellent acceleration performance. A plug 66 is fitted in the hole 67 and a screw 51 is used for urging a spring 20 against the plug 66 to form a single-way valve.

A vacuum hood 4, an exhaust hood 2 and a plate 6 are closely engaged with the gear assembly 3 by spring force, but it is difficult to keep the close engagement between the component parts in operation under different pressures. This is the primary purpose of the present invention to solve this problem As we know, friction force =normal force x friction coefficient. Hence, if the spring force is too high, there will be a braking effect thus decreasing the output power of the engine. If the spring force is too low, the vacuum hood 4 will cause backfire phenomenon and the exhaust hood 2 will cause leakage of the high pressure gas hence lowering the combustion efficiency. In addition, the plate 6 will lose control so that the engine will stop rotating. The plate 6 will require to balance the pressure at both sides thereof. When the internal pressure of the cylinder changes, the plate 6 will only require appropriate thrust for normal operation. The vacuum hood 4 only requires the turning of the screw rod 63 and the thrust of the spring 44 to make two circular arc plates 43 of the vacuum hood 4 locate against the tooth crest 58 of two gears 30 and 31 the space behind the two circular arc plates 43 of the exhaust hood 2 is communicated with the combustion chamber 57. The exhaust 54 is slightly turned to keep the close engagement between the circular arc plates 43 of the exhaust hood 2 and the gear assembly 3. It is difficult to control the pressure required for the vacuum hood 4 which is subject to different pressures of intake gas and combustion gas. It must be adapted to the disturbance produced in explosion under changes in pressure. Therefore, a linking rod 62 is connected to the rear side of the circular arc plate 43 of the vacuum hood 4 at its one end. The other end of the linking rod 62 is connected to a load cell for providing a predetermined pressure, which has three contacts for control the rotating direction of a synchronous motor 61. The motor 61 drives a screw rod 63 through a worm rod 64 and a worm gear 60 to adjust the pressure of a spring 44 against the vacuum hood 4. When the gears are subject to heat and expand, the vacuum hood 4 will be pushed by the linking rod 62 thereby pushing the load cell 65 against a circular disc 69. When it exceeds the predetermined pressure, the synchronous motor 61 will rotate the screw rod 63 to go outwardly to reduce the pressure exerted by the circular disc 69 on the load cell 65 until the predetermined pressure is recovered. However, when the gears contract in cooling, the synchronous motor 61 will rotate in a reverse direction until the load cell 65 recovers the predetermined pressure.

The gears instead of piston with rotate direction as shown in FIG. 1 and without single way bearing for it auxiliary if a single-way bearing (not shown) is fitted in each of axle seats 111 and 112 of the upper cylinder 1 for pivotally mounting the gears 30 and 31, the gears 30 and 31 will not rotate in a reverse direction.

The present invention applies two gears or rotors which are meshed with each other and disposed within a cylinder wherein one side of the cylinder sucks in gas while the other side of the cylinder exhausts waste gas. In addition, a portion of the waste gas is fed back tot he combustion chamber for increasing the combustion reaction rate. The present invention does not require water cooling and ignition control system and can operate at different pressures and temperatures. The present invention utilizes a small friction wear to obtain a large torque output and a small size to obtain a large power thereby making the present invention relatively low in cost.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A rotary gear engine comprising:
a pair of gears with identical pitch meshed with each other and disposed in a cylinder, said gears being mounted on a pair of parallel axles, a vacuum hood and an exhaust hood having two circular arc plates at two sides arranged opposite to said gears and urged by a spring against said gears, a plate mounted on said gears, whereby in operation, said engine sucks in gas at an end and exhaust air at the other, and two combustion chambers are formed in said cylinder for providing continuous high pressure gas to drive said gears.

2. The rotary gear engine as claimed in claim 1, further comprising a load cell which can be preset in pressure and is connected to said vacuum hood or in others dimension by a linking rod, so that when said gears expands, said load cell will push a circular disc to turn on a synchronous motor thereby causing a screw rod and a spring to move outwardly until pressure reaches a predetermined value thereby reducing pressure between said circular arc plates and tooth crest of said gears and therefore increasing mechanical advantage of said engine.

3. The rotary gear engine as claimed in claim 1, wherein a portion or all of said waste gas is fed back to said combustion chamber via a valve to increase pressure in said combustion chamber thus increasing combustion rate.

4. The rotary gear engine as claimed in claim 1, wherein said circular arc plate has a curved surface which is longer than pitch of said gears and has a curvature adapted to said gears.
